(19) United States
(12) Patent Application Publication
(10) Pub. No.: US 2026/0072805 A1
(43) Pub. Date: Mar. 12, 2026

(54) PERFORMANCE MAINTENANCE SYSTEM AND PERFORMANCE MAINTENANCE METHOD

(71) Applicant: MEDIATEK INC., Hsinchu City (TW)

(72) Inventors: Chih-Chieh CHOU, Hsinchu City (TW); Wei-Cheng TANG, Hsinchu City (TW); Hsuan-Jung HSU, Hsinchu City (TW); Shih-Che HUNG, Hsinchu City (TW); Jyun-Hao HUANG, Hsinchu City (TW); Li-Hung CHIUEH, Hsinchu City (TW); Hsin-Yu WANG, Hsinchu City (TW)

(21) Appl. No.: 19/321,516

(22) Filed: Sep. 8, 2025

Related U.S. Application Data
(60) Provisional application No. 63/693,266, filed on Sep. 11, 2024.

(51) Int. Cl. G06F 11/34; G06F 1/3206; G06F 1/3296

(52) U.S. Cl. CPC G06F 11/3409; G06F 1/3206; G06F 1/3296; G06F 2201/81

(57) ABSTRACT

A performance maintenance system includes a first device, a host, and a processor. The host includes a host controller, a transport protocol layer component, a physical layer component. The processor is configured to execute the following steps based on a plurality of instructions from a memory: entering a first mode; monitoring the plurality of signals and the temperature signal; determining whether a first value of the plurality of signals or a second value of the temperature signal is greater than a voltage threshold value or a temperature threshold value; when it is determined that the first value of the plurality of signals or the second value of the temperature signal is greater than the voltage threshold value or the temperature threshold value, exiting the first mode; and controlling the first device to send a training signal to a first receiver of the host.

### CROSS REFERENCE TO RELATED APPLICATIONS

This application claims priority of U.S. Provisional Application No. 63/693,266, filed on Sep. 11, 2024, the entirety of which is incorporated by reference herein.

### BACKGROUND OF THE INVENTION

### Field of the Invention

The present invention relates to a maintenance system and maintenance method, and, in particular, to a performance maintenance system and performance maintenance method.

### Description of the Related Art

Currently, when the first receiver of a UFS (Universal Flash Storage) system or architecture fails, it can be corrected by hardware or software to maintain normal operation.

However, with the introduction of new signals (such as PAM4 signals), the operating margin of the first receiver is reduced. When the environment or signal drifts (e.g., voltage/temperature drift), the risk of first receiver operation failure increases. Furthermore, if correction is performed using existing hardware or software within the system, it often takes more time, thereby reducing the operating efficiency of the system.

Therefore, a highly efficient performance maintenance system that continuously maintains normal receiver performance is an urgently needed research and development item.

### BRIEF SUMMARY OF THE INVENTION

An embodiment of the present invention provides a performance maintenance system. The performance maintenance system includes a first device, a host, a signal tracker, and a processor. The host includes a host controller, a transport protocol layer component, a physical layer component. The physical layer component is configured to receive a plurality of signals. The signal tracker is configured to track the plurality of signals in the physical layer component. The processor is configured to execute the following steps based on a plurality of instructions from a memory: entering a first mode; monitoring the plurality of signals of the host; determining whether a first value of the plurality of signals is greater than a threshold value; when it is determined that the first value of the plurality of signals is greater than the threshold value, the host exits the first mode; and controlling the first device to send a training signal to a first receiver of the host.

In one embodiment, wherein the first mode includes a low power mode; wherein the plurality of signals includes at least one of a plurality of voltage signals and a temperature signal; wherein the training signal is related to an adaptation signal.

In one embodiment, the performance maintenance system further includes a signal quality tracker. The signal quality tracker is configured to obtain a quality data from the transport protocol layer component or the physical layer component. The processor further executes the following steps based on the plurality of instructions from the memory: monitoring the quality data of the host; determining whether a third value of the quality data is greater than a quality threshold value; and when it is determined that the third value of the quality data is greater than the quality threshold value, the host exits the first mode.

In one embodiment, wherein the signal tracker comprises a voltage tracker and a temperature tracker; wherein the voltage tracker is configured to track the plurality of signals in the physical layer component; wherein the temperature tracker is configured to track a temperature signal in the physical layer component; wherein the processor further executes the following steps based on the plurality of instructions from the memory: exiting the first mode to transfer a data signal; sending the data signal by the host while monitoring the plurality of signals or the temperature signal; determining whether the first value of the plurality of signals or the second value of the temperature signal is greater than the voltage threshold value or the temperature threshold value; and when it is determined that the first value of the plurality of signals or the second value of the temperature signal is greater than the voltage threshold value or the temperature threshold value, the host controls the first device to send a training signal to the first receiver of the host.

In one embodiment, wherein the processor further executes the following steps based on the plurality of instructions from the memory: determining whether the data signal is transferred; and when it is determined that the data signal is not transferred, the host enters the first mode.

In one embodiment, wherein the processor further executes the following steps based on the plurality of instructions from the memory: sending the data signal by the host while monitoring the quality data; determining whether a third value of the quality data is greater than a quality threshold value; when it is determined that the third value of the quality data is greater than the quality threshold value, the host controls the first device to send a training signal to the first receiver of the host.

In one embodiment, wherein the signal tracker comprises a voltage tracker and a temperature tracker; wherein the voltage tracker is configured to track the plurality of signals in the physical layer component; wherein the temperature tracker is configured to track a temperature signal in the physical layer component; wherein the processor further executes the following steps based on the plurality of instructions from the memory: obtaining a reference data; and when it is determined that the first value of the plurality of signals or the second value of the temperature signal is greater than the voltage threshold value or the temperature threshold value, sending a first fine-tuning parameter data or a second fine-tuning parameter data to the first receiver of the host; wherein the first fine-tuning parameter data and the second fine-tuning parameter data are related to the reference data; wherein the first fine-tuning parameter data is related to one of the plurality of signals; wherein the second fine-tuning parameter data is related to the temperature signal.

In one embodiment, the performance maintenance system further includes a signal quality tracker. The signal quality tracker is configured to obtain a quality data from the transport protocol layer component or the physical layer component. The processor further executes the following steps based on the plurality of instructions from the memory: monitoring the quality data; determining whether a third value of the quality data is greater than a quality threshold value; and when it is determined that the third value of the quality data is greater than the quality threshold value, sending a third fine-tuning parameter data to the first receiver of the host; wherein the third fine-tuning parameter data are related to the reference data; wherein the third fine-tuning parameter data is related to the quality data.

In one embodiment, wherein a look-up table data includes the reference data; wherein the processor further executes the following steps based on the plurality of instructions from the memory: collecting a plurality of fine-tuning parameter data of the look-up table data based on the plurality of signals, the temperature signal, the quality data, and at least one of a plurality of normal data and a plurality of corner data associated with integrated circuits; wherein the plurality of fine-tuning parameter data includes the first fine-tuning parameter data, the second fine-tuning parameter data, and the third fine-tuning parameter data.

In one embodiment, wherein the processor further executes the following steps based on the plurality of instructions from the memory: calibrating the first receiver of the host based on the plurality of fine-tuning parameter data when the performance maintenance system enters a low power mode or a suspend mode.

Other embodiment of the present invention provides a performance maintenance method. The performance maintenance method includes the following steps: entering a first mode; monitoring a plurality of signals; determining whether a first value of the plurality of signals is greater than a threshold value; when it is determined that the first value of the plurality of signals is greater than the voltage threshold value or the temperature threshold value, exiting the first mode; and controlling a first device to send a training signal to a first receiver of the host. Wherein a signal tracker is configured to track the plurality of signals in a physical layer component.

In one embodiment, wherein the first mode includes a low power mode; wherein the plurality of signals includes at least one of a plurality of voltage signals and a temperature signal; wherein the training signal is related to an adaptation signal.

In one embodiment, the performance maintenance method further includes the following steps: monitoring a quality data; determining whether a third value of the quality data is greater than a quality threshold value; and when it is determined that the third value of the quality data is greater than the quality threshold value, exiting the first mode; wherein a signal quality tracker is configured to obtain the quality data from a transport protocol layer component or the physical layer component.

In one embodiment, the performance maintenance method further includes the following steps: exiting the first mode to transfer a data signal; sending the data signal while monitoring the plurality of signals or the temperature signal; determining whether the first value of the plurality of signals or the second value of the temperature signal is greater than the voltage threshold value or the temperature threshold value; and when it is determined that the first value of the plurality of signals or the second value of the temperature signal is greater than the voltage threshold value or the temperature threshold value, controlling the first device to send a training signal to the first receiver of the host.

In one embodiment, the performance maintenance method further includes the following steps: determining whether the data signal is transferred; and when it is determined that the data signal is not transferred, entering the first mode.

In one embodiment, the performance maintenance method further includes the following steps: sending the data signal while monitoring the quality data; determining whether a third value of the quality data is greater than a quality threshold value; when it is determined that the third value of the quality data is greater than the quality threshold value, controlling the first device to send a training signal to the first receiver of the host.

In one embodiment, the performance maintenance method further includes the following steps: obtaining a reference data; when it is determined that the first value of the plurality of signals or the second value of the temperature signal is greater than the voltage threshold value or the temperature threshold value, sending a first fine-tuning parameter data or a second fine-tuning parameter data to the first receiver of the host; wherein the first fine-tuning parameter data and the second fine-tuning parameter data are related to the reference data; wherein the first fine-tuning parameter data is related to one of the plurality of signals; wherein the second fine-tuning parameter data is related to the temperature signal.

In one embodiment, the performance maintenance method further includes the following steps: monitoring the quality data; determining whether a third value of the quality data is greater than a quality threshold value; and when it is determined that the third value of the quality data is greater than the quality threshold value, sending a third fine-tuning parameter data to the first receiver of the host; wherein the third fine-tuning parameter data are related to the reference data; wherein the third fine-tuning parameter data is related to the quality data; wherein a signal quality tracker is configured to obtain the quality data from a transport protocol layer component or the physical layer component.

In one embodiment, the performance maintenance method further includes the following steps: collecting a plurality of fine-tuning parameter data of a look-up table data based on the plurality of signals, the temperature signal, the quality data, and at least one of a plurality of normal data and a plurality of corner data associated with integrated circuits; wherein the plurality of fine-tuning parameter data includes the first fine-tuning parameter data, the second fine-tuning parameter data, and the third fine-tuning parameter data; wherein a look-up table data includes the reference data.

In one embodiment, the performance maintenance method further includes the following steps: calibrating the first receiver of the host based on the plurality of fine-tuning parameter data when a system enters a low power mode or a suspend mode.

Therefore, according to the technical content of the present disclosure, the performance maintenance system and performance maintenance method shown in the embodiment of the present disclosure can achieve the effect of continuously maintaining normal receiver operation and maintaining high performance efficiency of the system.

Other features and aspects of the present disclosure will become apparent from the following detailed description of exemplary embodiments with reference to the accompanying drawings.

### BRIEF DESCRIPTION OF THE DRAWINGS

The views of the embodiments of the present disclosure can be better understood through the following detailed description combined with the accompanying drawings. It is worth noting that, according to standard industrial practice, some features may not be drawn to scale. In fact, to facilitate clear description, the dimensions of different features may be increased or decreased, wherein:

FIG. 1 is a block diagram of a performance maintenance system according to one embodiment of the present disclosure.

FIG. 2 is an operational schematic diagram of a performance maintenance system according to one embodiment of the present disclosure.

FIG. 3A is a plurality of signal timing diagrams of a performance maintenance system according to one embodiment of the present disclosure.

FIG. 3B is a plurality of signal timing diagrams of a performance maintenance system according to one embodiment of the present disclosure.

FIG. 4 is an operational schematic diagram of a performance maintenance system according to one embodiment of the present disclosure.

FIG. 5 is an operational schematic diagram of a performance maintenance system according to one embodiment of the present disclosure.

FIG. 6 is a flowchart of a performance maintenance method according to one embodiment of the present disclosure.

### DETAILED DESCRIPTION OF THE INVENTION

The following description is made for the purpose of illustrating the general principles of the invention and should not be taken in a limiting sense. The scope of the invention is best determined by reference to the appended claims.

To make the description of the present disclosure more detailed and complete, illustrative descriptions are provided below for the implementation aspects and specific embodiments of the present case. However, this is not the sole form of implementing or utilizing the specific embodiments of the present case. The embodiments cover the features of multiple specific embodiments as well as the method steps and their sequence for constructing and operating these specific embodiments. Nevertheless, the same or equivalent functions and sequence of steps can also be achieved using other specific embodiments.

Unless otherwise defined in this specification, the meaning of scientific and technical terms used herein is the same as commonly understood and customary by a person having ordinary skill in the art to which the present case pertains. Furthermore, without conflicting with the context, singular nouns used in this specification cover their plural forms; and plural nouns also cover their singular forms.

In some embodiments of the present disclosure, terms related to joining and connecting, such as “connect,” “interconnect,” and “bond,” unless specifically defined otherwise, may refer to situations where two structures are in direct contact, or may also refer to situations where two structures are not in direct contact, with other structures arranged between these two structures. Moreover, these terms related to connecting and joining may also include cases where both structures are movable, or both structures are fixed. Additionally, “coupled” or “connected” as used herein may refer to two or more components being in direct physical or electrical contact with each other, or indirect physical or electrical contact with each other, and may also refer to two or more components interacting or operating with each other.

Some embodiments of the present disclosure can be understood in conjunction with the drawings, and the drawings of the embodiments of the present disclosure are also considered as part of the description of the embodiments of the present disclosure. It should be understood that the drawings of the embodiments of the present disclosure are not drawn to the actual scale of devices and components. The shapes and thicknesses of the embodiments may be exaggerated in the drawings to clearly illustrate the features of the embodiments of the present disclosure. Furthermore, the structures and devices in the drawings are schematically illustrated to clearly illustrate the features of the embodiments of the present disclosure.

Herein, the term “system” or “device” generally refers to an object connected in a certain way to process signals, composed of one or more transistors and/or one or more active/passive components.

Here, the terms “about,” “approximately,” and “roughly” generally indicate within 20% of a given value or range, preferably within 10%, and more preferably within 5%, or within 3%, or within 2%, or within 1%, or within 0.5%. The quantities given herein are approximate quantities, meaning that the meaning of “about,” “approximately,” or “roughly” may still be implicitly included even without specific mention of “about,” “approximately,” or “roughly”. The term “a range between a first value and a second value” means that the described range includes the first value, the second value, and other values between them. Furthermore, a certain error may exist between any two values or directions used for comparison. If the first value is equal to the second value, it implies that there may be an error of about 10%, or within 5%, or within 3%, or within 2%, or within 1%, or within 0.5% between the first value and the second value. If the first direction is perpendicular to the second direction, the angle between the first direction and the second direction may be between 80 degrees and 100 degrees. If the first direction is parallel to the second direction, the angle between the first direction and the second direction may be between 0 degrees and 10 degrees.

Certain terms will be used throughout the entire specification and claims of the present disclosure to refer to specific components. A person having ordinary skill in the art should understand that electronic device manufacturers may refer to the same components by different names. This document is not intended to distinguish between components that have the same function but different names. In the following specification and claims, terms such as “comprising,” “containing,” and “having” are open-ended terms, and therefore they should be interpreted as “containing but not limited to . . . ”. Thus, when the terms “comprising,” “containing,” and/or “having” are used in the description of the present disclosure, they specify the presence of corresponding parts, regions, steps, operations, and/or elements, but do not exclude the presence of one or more corresponding parts, regions, steps, operations, and/or elements.

It should be understood that the components from multiple different embodiments can be substituted, rearranged, and combined to complete other embodiments without departing from the spirit of the present disclosure. Components between various embodiments can be arbitrarily combined and used together, as long as they do not violate the spirit of the invention or conflict with each other.

Unless otherwise defined, all terms used herein (including technical and scientific terms) have the same meaning as commonly understood by a person having ordinary skill in the art to which the present disclosure pertains. It can be understood that these terms, for example, terms defined in commonly used dictionaries, should be interpreted as having a meaning consistent with the relevant art and the background or context of the present disclosure, and should not be interpreted in an idealized or overly formal sense, unless specifically defined in the embodiments of the present disclosure.

In the present disclosure, various directions are not limited to the three axes like the X-axis, Y-axis, and Z-axis of a Cartesian coordinate system, and can be interpreted in a broader sense. For example, the X-axis, Y-axis, and Z-axis may be perpendicular to each other, or may represent different directions that are not perpendicular to each other, but are not limited thereto. For convenience of description, hereinafter, the X-axis direction is the first direction (width direction), the Y-axis direction is the second direction (length direction), and the Z-axis direction is the third direction (thickness or height direction). In some embodiments, the cross-sectional schematic view described herein is a cross-sectional schematic view observed in the XZ plane. In some embodiments, the third direction may be the normal direction of the substrate. In some embodiments, the third direction may be the front direction of the performance maintenance system.

In some embodiments, additional components may be added to the performance maintenance system of the present disclosure. In some embodiments, some components of the performance maintenance system of the present disclosure may be replaced or omitted. In some embodiments, additional operational steps may be provided before, during, and/or after the manufacturing method of the performance maintenance system. In some embodiments, some of the described operational steps may be replaced or omitted, and the sequence of some of the described operational steps is interchangeable. Furthermore, it should be understood that some of the described steps may be replaced or deleted for other embodiments of the method. Moreover, in the present disclosure, the number and size of each component in the drawings are for illustrative purposes only, and are not intended to limit the scope of the present disclosure.

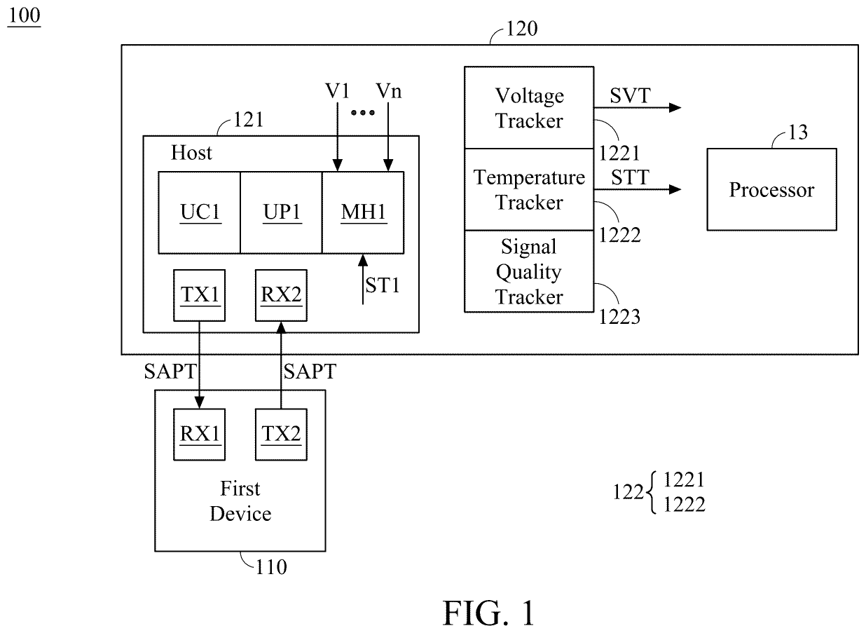

FIG. 1 is a block diagram of a performance maintenance system according to one embodiment of the present disclosure. As shown in FIG. 1, in one embodiment, the performance maintenance system 100 includes a first device 110, a host 121, a voltage tracker 1221, a temperature tracker 1222, and a processor 13. The host 121 includes a host controller UC1, a transport protocol layer component UP1, a physical layer component MH1. In coupling relationship, the first device 110 may be coupled to the host 121, the host 121 may be coupled to the voltage tracker 1221, the host 121 may be coupled to the temperature tracker 1222, and the host 121 may be coupled to the processor 13. The host controller UC1, the transport protocol layer component UP1, the physical layer component MH1 may be coupled to each other.

For example, the host 121 may be an Universal Flash Storage Host (UFSH), the host controller UC1 may be an Universal Flash Storage Host Controller (UFSHC), transport protocol layer component UP1 may be an Unified Protocol (UniPro) module, and the physical layer component MH1 may be a MIPI M-PHY (MPHY) module, but the present disclosure is not limited thereto.

In some embodiments, a second device 120 may include the host 121, the voltage tracker 1221, the temperature tracker 1222, a signal quality tracker 1223, and the processor 13. The host may include the host controller UC1, the transport protocol layer component UP1, the physical layer component MH1, a transmitter TX1, and a receiver RX2. The first device 110 may include a transmitter TX2, and a receiver RX1, but the present disclosure is not limited thereto.

For example, the voltage tracker 1221 may be a Servo Analog-to-Digital Converter (servo ADC), the temperature tracker 1222 may be a thermal sensor (or thermo sensor), the signal quality tracker 1223 may be a Quality of Service (QoS) statistics, but the present disclosure is not limited thereto.

In some embodiments, the voltage tracker 1221 and the temperature tracker 1222 may constitute to a signal tracker 122, but the present disclosure is not limited thereto. In some embodiments, the voltage tracker 1221 may correspond to the signal tracker 122, but the present disclosure is not limited thereto.

In some embodiments, the voltage tracker 1221 may output track signal SVT according to the plurality signals V1 to Vn, the temperature tracker 1222 may output track signal STT according to the temperature signal ST1, but the present disclosure is not limited thereto.

In some embodiments, the host 121 may be a System-on-Chip (SoC), a Microprocessor Unit (MPU), a Graphics Processing Unit (GPU), a Microcontroller Unit (MCU), a microprocessor, a digital signal processor (DSP), a Field Programmable Gate Array (FPGA), an Application Specific Integrated Circuit (ASIC), or a server, among others, but the present disclosure is not limited thereto.

In some embodiments, the processor 13 may be a Central Processing Unit (CPU), a Microprocessor Unit (MPU), a Graphics Processing Unit (GPU), a Microcontroller Unit (MCU), a microprocessor, a digital signal processor (DSP), a Field Programmable Gate Array (FPGA), an Application Specific Integrated Circuit (ASIC), or a server, among others, but the present disclosure is not limited thereto.

In one embodiment, the physical layer component MH1 is configured to receive a plurality of signals. The signal tracker 122 is configured to track the plurality of signals (such as signals V1 to Vn) in the physical layer component MH1.

For example, the plurality of signals may include at least one of the plurality of voltage signals V1 to Vn and the temperature signal ST1, the signal tracker 122 may include at least one of the voltage tracker 1221 and the temperature tracker 1222, but the present disclosure is not limited thereto.

In some embodiments, the voltage tracker 1221 is configured to track the plurality of signals V1 to Vn in the physical layer component MH1. The temperature tracker 1222 is configured to track a temperature signal ST 1 in the physical layer component MH1.

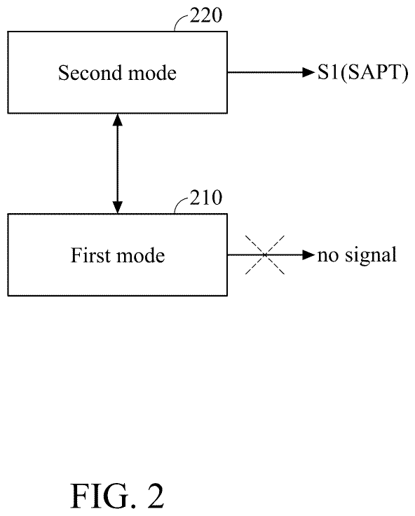

FIG. 2 is an operational schematic diagram of a performance maintenance system according to one embodiment of the present disclosure. As shown in FIG. 2, in one embodiment, FIG. 2 may include a first mode 210 and a second mode 220.

For example, the first mode 210 may correspond to a low power mode, the second mode 220 may correspond to a High-Speed (HS) Burst Mode, but the present disclosure is not limited thereto. The first mode 210 may be referred to as a first state, the second mode 220 may be referred to as a second state, but the present disclosure is not limited thereto.

In some embodiments, the receiver (or the transmitter) of the MPHY may switch to the first mode 210 or the second mode 220, but the present disclosure is not limited thereto. In some embodiments, the host 121 (or the performance maintenance system 100) shown in FIG. 1 may switch to the first mode 210 or the second mode 220, but the present disclosure is not limited thereto.

In some embodiments, when the host 121 switches to the first mode 210, the host 121 may not transmit any signal, but the present disclosure is not limited thereto. In some embodiments, when the host 121 switches to the second mode 220, the host 121 may transmit the signal S1 or an Adaptive Adjustment Process for Training (ADAPT) signal SAPT, but the present disclosure is not limited thereto.

In some embodiments, generally in the art, since UFS 5.0, PAM4 signaling is introduced for HS-G6 (and above); PAM4 has intrinsically smaller margin compared to NRZ signaling for HS-G1 to HS-G5. MPHY RX performance degradation because of voltage/temperature drift becomes more critical than ever. MPHY RX may not receive signal correctly, when there is high voltage/temperature drift.

Since last ADAPT in BURST: if drift is large, RX tracking of BURST data may not be enough. Link issue may happen. Since entry to H8: no data for RX tracking in this state. H8 exit may fail. Yet, hardware (HW) recovery methods in current protocol stack may not cover such performance drift. Host driver (SW) has to do error handling to cover these link issues. It takes long time and impair overall UFS performance, but the present disclosure is not limited thereto.

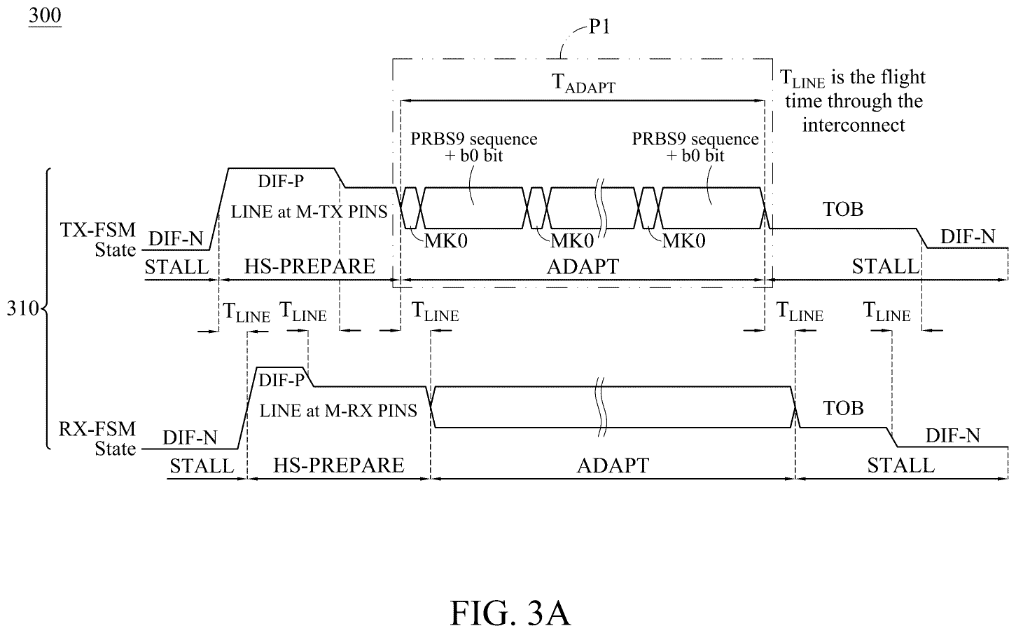

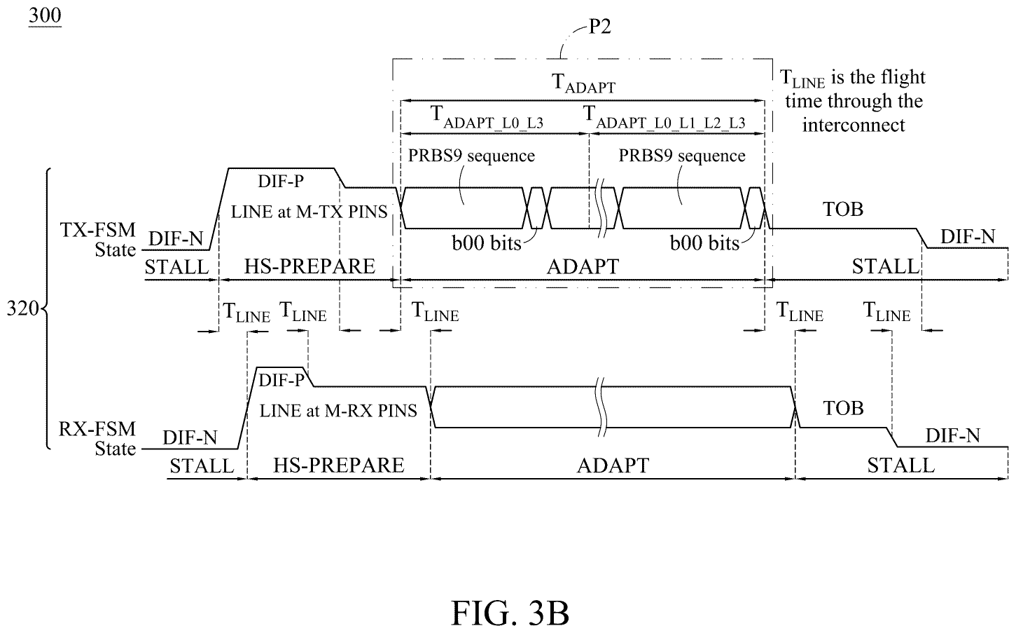

FIG. 3A is a plurality of signal timing diagrams of a performance maintenance system according to one embodiment of the present disclosure. As shown in FIG. 3A, in one embodiment, the states of the signals 310 may include TX-FSM state and RX-FSM state. The TX-FSM state may include a first pattern data P1. The first pattern data P1 is related to ADAPT.

FIG. 3B is a plurality of signal timing diagrams of a performance maintenance system according to one embodiment of the present disclosure. As shown in FIG. 3B, in one embodiment, the states of the signals 320 may include the TX-FSM state and the RX-FSM state. The TX-FSM state may include a second pattern data P1. The second pattern data P2 is related to ADAPT.

Please refer to FIG. 3A, and FIG. 3B, in some embodiments, the host 121 shown in FIG. 1 may initiate power mode change by sending PACP_PWR_Req packet. In the present disclosure, the receiver may be represented by “RX” and the transmitter may be represented by “TX”, but the present disclosure is not limited thereto.

In some embodiments, the host 121 shown in FIG. 1 may request host TX (such as the transmitter TX2) and device TX (such as the transmitter TX1) to send ADAPT or not, by setting “Adapt” value in PACP_PWR_Req. Furthermore, Adapt is long PRBSx pattern (such as the first pattern data P1 and the second pattern data P2) for RX training, but the present disclosure is not limited thereto.

In some embodiments, the signal group 300 may include the signals 310 and the signals 320. The signals 310 may include the first pattern data P1, the signals 320 may include the second pattern data P2, and the first pattern data P1 and the second pattern data P2 are different from each other, but the present disclosure is not limited thereto.

In some embodiments, the first pattern data P1 may be a first type of training signal, the second pattern data P2 may be a second type of training signal, but the present disclosure is not limited thereto.

Please refer to FIG. 1 to FIG. 3B, in one embodiment, the processor 13 is configured to execute the following steps based on a plurality of instructions from a memory: entering a first mode 210 by the host 121; monitoring the plurality of signals (such as signals V1 to Vn); determining whether a first value of the plurality of signals is greater than a threshold value; when it is determined that the first value of the plurality of signals is greater than the voltage threshold value or the temperature threshold value, the host 121 exits the first mode 210; and controlling, by the host 121, the first device 110 to send a training signal SAPT to a first receiver RX2 of the host 121.

For example, the plurality of signals V1 to Vn may include −10 to 10 Volt (V), the temperature signal ST1 may include −50 to 50° C., the voltage threshold value may be 5V, and the temperature threshold value may be 40° C. The training signal SAPT may correspond to the first pattern data P1 and/or the second pattern data P2, but the present disclosure is not limited thereto.

In some embodiments, each one of the plurality of signals V1 to Vn may correspond to one of the threshold values, but the present disclosure is not limited thereto. In some embodiments, the plurality of signals V1 to Vn may correspond to different threshold values, but the present disclosure is not limited thereto.

In some embodiments, the processor 13 (or the host 121) is configured to execute the following steps based on a plurality of instructions from a memory: entering a first mode 210 by the host 121; monitoring the plurality of signals V1 to Vn and the temperature signal ST1; determining whether a first value of the plurality of signals V1 to Vn or a second value of the temperature signal ST1 is greater than a voltage threshold value or a temperature threshold value; when it is determined that the first value of the plurality of signals V1 to Vn or the second value of the temperature signal ST1 is greater than the voltage threshold value or the temperature threshold value, the host 121 exits the first mode 210; and controlling, by the host 121, the first device 110 to send a training signal SAPT to a first receiver RX2 of the host 121.

In some embodiments, the processor 13 may determine whether the first value of the plurality of signals V1 to Vn is greater than a voltage threshold value. When it is determined that the first value of the plurality of signals V1 to Vn is greater than the voltage threshold value, the processor 13 (or the host 121) may exit the first mode 210, but the present disclosure is not limited thereto.

In some embodiments, the processor 13 may determine whether the second value of the temperature signal ST1 is greater than the temperature threshold value. When it is determined that the second value of the temperature signal ST1 is greater than the temperature threshold value, the processor 13 (or the host 121) may exit the first mode 210, but the present disclosure is not limited thereto.

In one embodiment, the first mode 210 (shown in FIG. 2) includes a low power mode. The plurality of signals V1 to Vn includes a plurality of voltage signals. The training signal is related to an adaptation signal.

For example, the plurality of signals V1 to Vn may correspond to voltages, the training signal SAPT may correspond to ADAPT signal, but the present disclosure is not limited thereto.

In one embodiment, the performance maintenance system 100 further includes a signal quality tracker 1223. The signal quality tracker 1223 is configured to obtain a quality data from the transport protocol layer component UP1 or the physical layer component MH1. The processor 13 further executes the following steps based on the plurality of instructions from the memory: monitoring the quality data of the host 121; determining whether a third value of the quality data is greater than a quality threshold value; and when it is determined that the third value of the quality data is greater than the quality threshold value, the host 121 exits the first mode 210.

For example, the third value of the quality data may include 1% and 3%, but the present disclosure is not limited thereto.

In some embodiments, the third value of the quality data may a recovered rate. For example, the processor 13 may check if recovered rate is increased to know if the quality data is getting worse, but the present disclosure is not limited thereto.

In some embodiments, the recovered rate (or the third value of the quality data) may be described by Equation 1, and the related content will be explained in detail hereinafter.

$$recovered rate = \frac{recovered symbol by FEC}{total symbol} . \qquad Equation 1$$

As described above, in some embodiments, the recovered rate may have a proportional relationship with the third value of the quality data, the recovered symbol may be obtained from Forward Error Correction (FEC), the total symbol may include all data of the host 121, but the present disclosure is not limited thereto.

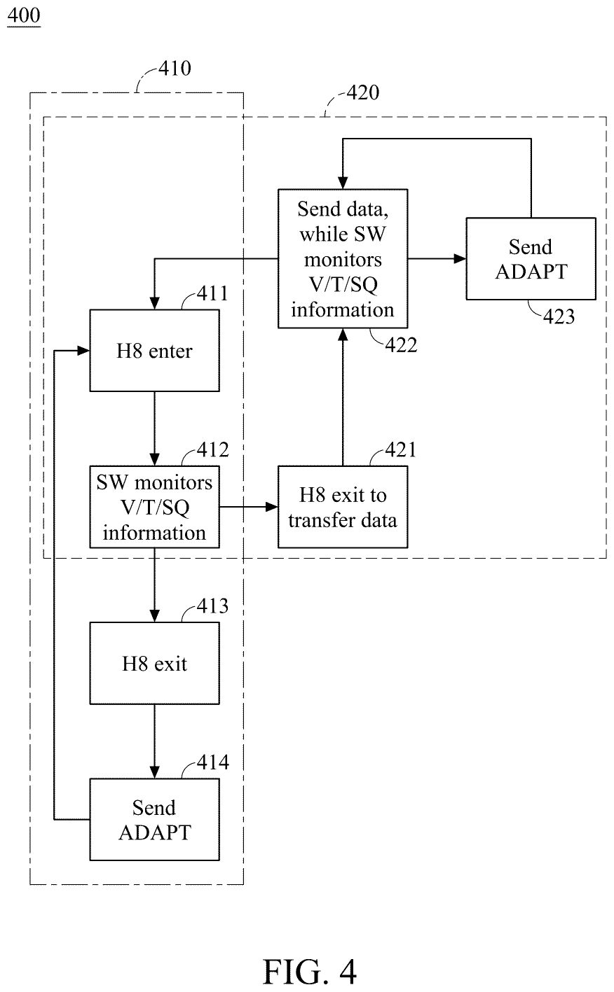

FIG. 4 is an operational schematic diagram of a performance maintenance system according to one embodiment of the present disclosure. As shown in FIG. 4, in one embodiment, the operational schematic diagram 400 may include a first operation 410 and a second operation 420. The first operation 410 may include a plurality of steps 411 to 414. The second operation 420 may include a plurality of steps 411, 412, 421 to 423.

For a detailed description of the technical content of the plurality of steps 411 to 414 and the plurality of steps 411, 412, 421 to 423 shown in FIG. 4. Please also refer to FIG. 1 to FIG. 4. The following provides a detailed explanation of the plurality of steps 411 to 414 and the plurality of steps 411, 412, 421 to 423.

In the step 411, H8 enter.

In one embodiment, the host 121 may enter H8 state.

For example, the H8 state may correspond to HIBERN8 state (or the low power mode), but the present disclosure is not limited thereto.

In one embodiment, the host 121 may enter the first mode 210.

In some embodiments, after the processor 13 (or the host 121) executes step 411, the processor 13 (or the host 121) may subsequently execute step 412.

In the step 412, SW monitors VT/SQ information.

In one embodiment, the processor 13 may monitor VT/SQ information by using the software (SW).

For example, V information may correspond to the plurality of signals V1 to Vn, T information may correspond to the temperature signal ST1, and SQ information may correspond to the quality data from the transport protocol layer component UP1 or the physical layer component MH1, but the present disclosure is not limited thereto.

In one embodiment, the processor 13 may monitor the plurality of signals V1 to Vn and the temperature signal ST1.

In one embodiment, the processor 13 may monitor the quality data.

In some embodiments, between the step 412 and step 413 may have a sub-step.

In some embodiments, the sub-step may correspond to “determining whether a first value of the plurality of signals V1 to Vn or a second value of the temperature signal ST1 is greater than a voltage threshold value or a temperature threshold value.”

In some embodiments, the sub-step may correspond to “determining whether a third value of the quality data is greater than a quality threshold value.”

In some embodiments, after the processor 13 (or the host 121) executes step 412, the processor 13 (or the host 121) may subsequently execute step 413. In some embodiments, after the processor 13 (or the host 121) executes step 412, the processor 13 (or the host 121) may subsequently execute step 421.

In the step 413, H8 exit.

In one embodiment, the host 121 may exit H8 state.

In one embodiment, when it is determined that the first value of the plurality of signals V1 to Vn or the second value of the temperature signal ST1 is greater than the voltage threshold value or the temperature threshold value, the host 121 may exit the first mode 210.

In one embodiment, when it is determined that the third value of the quality data is greater than the quality threshold value, the host 121 may exit the first mode 210.

In some embodiments, after the processor 13 (or the host 121) executes step 413, the processor 13 (or the host 121) may subsequently execute step 414.

In the step 414, Send ADAPT.

In one embodiment, the host 121 may send ADAPT signal.

In one embodiment, the host 121 may control the first device 110 to send the training signal SAPT to the first receiver RX2 of the host 121.

In some embodiments, when the transmitter TX2 of the first device 110 sends the training signal SAPT to the first receiver RX2 of the host 121, the transmitter TX1 of the host 121 correspondingly sends the training signal SAPT to the receiver RX1 of the first device 110.

In some embodiments, after the processor 13 (or the host 121) executes step 414, the processor 13 (or the host 121) may subsequently execute step 411.

In the step 421, H8 exit to transfer data.

In one embodiment, the host 121 may exit H8 state to transfer data.

In one embodiment, the host 121 may exit the first mode 210 to transfer a data signal.

In some embodiments, after the processor 13 (or the host 121) executes step 421, the processor 13 (or the host 121) may subsequently execute step 422.

In the step 422, Send data, while SW monitors V/T/SQ information.

In one embodiment, the processor 13 may send data, while SW monitors V/T/SQ information.

In one embodiment, the processor 13 may send the data signal while monitoring the plurality of signals V1 to Vn and the temperature signal ST1.

In one embodiment, the processor 13 (or the host 121) may sending the data signal while the processor 13 monitoring the quality data.

In some embodiments, after the processor 13 (or the host 121) executes step 422, the processor 13 (or the host 121) may subsequently execute step 423.

In some embodiments, after the processor 13 (or the host 121) executes step 423, the processor 13 (or the host 121) may subsequently execute step 420.

In some embodiments, between the step 422 and step 423 may have a sub-step.

In some embodiments, the sub-step may correspond to “determining whether the first value of the plurality of signals or the second value of the temperature signal is greater than the voltage threshold value or the temperature threshold value.”

In some embodiments, the sub-step may correspond to “determining whether a third value of the quality data is greater than a quality threshold value.”

In some embodiments, after the processor 13 (or the host 121) executes step 422, the processor 13 (or the host 121) may subsequently execute step 411.

In some embodiments, between the step 422 and step 411 may have a sub-step.

In some embodiments, the sub-step may correspond to “determining whether the data signal is transferred; and when it is determined that the data signal is not transferred, entering the first mode.”

For example, the processor 13 (or the host 121) may determine whether the data signal is transferred. When it is determined that the data signal is not transferred, the host 121 may enter the first mode, but the present disclosure is not limited thereto.

In the step 423, Send ADAPT.

In one embodiment, the host 121 may send ADAPT signal.

In one embodiment, when it is determined that the first value of the plurality of signals V1 to Vn or the second value of the temperature signal ST1 is greater than the voltage threshold value or the temperature threshold value, the host 121 may control the first device 110 to send a training signal SAPT to the first receiver RX2 of the host 121.

In one embodiment, when it is determined that the third value of the quality data is greater than the quality threshold value, the host 121 may control the first device to send a training signal SAPT to the first receiver RX2 of the host 121.

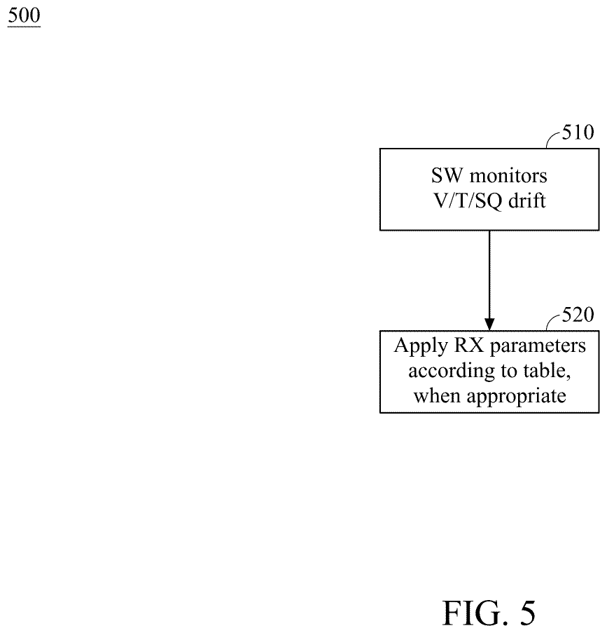

FIG. 5 is an operational schematic diagram of a performance maintenance system according to one embodiment of the present disclosure. As shown in FIG. 5, in one embodiment, the operational schematic diagram 500 may include a plurality of steps 510 and 520.

For a detailed description of the technical content of the plurality of steps 510 and 520 in FIG. 5, please also refer to FIG. 1 to FIG. 5. The following provides a detailed explanation of the plurality of steps 510 and 520.

In the step 510, SW monitors V/T/SQ drift.

In one embodiment, the processor 13 may monitor V/T/SQ drift by using software (SW).

In one embodiment, the processor 13 may correspond to the step 412 or the step 422.

For example, the operations of the step 510 show in FIG. 5 may be similar to the operations of the step 412 show in FIG. 4, the operations of the step 510 show in FIG. 5 may be similar to the operations of the step 422 show in FIG. 4, detailed description thereof will be omitted herein for brevity, but the present disclosure is not limited thereto.

In the step 520, Apply RX parameters according to table, when appropriate.

In one embodiment, the processor 13 may apply RX parameters according to table, when appropriate.

In one embodiment, the step 520 further includes the following steps: obtaining a reference data; when it is determined that the first value of the plurality of signals V1 to Vn or the second value of the temperature signal ST1 is greater than the voltage threshold value or the temperature threshold value, sending a first fine-tuning parameter data or a second fine-tuning parameter data to the first receiver RX2 of the host 110.

In one embodiment, the first fine-tuning parameter data and the second fine-tuning parameter data are related to the reference data. The first fine-tuning parameter data is related to one of the plurality of signals V1 to Vn. The second fine-tuning parameter data is related to the temperature signal ST1.

In one embodiment, the step 520 further includes the following steps: determining whether a third value of the quality data is greater than a quality threshold value; and when it is determined that the third value of the quality data is greater than the quality threshold value, sending a third fine-tuning parameter data to the first receiver RX2 of the host 110.

In one embodiment, the third fine-tuning parameter data are related to the reference data. The third fine-tuning parameter data is related to the quality data.

In one embodiment, the step 520 further includes the following steps: collecting a plurality of fine-tuning parameter data of the look-up table data based on the plurality of signals V1 to Vn, the temperature signal ST1, the quality data, and at least one of a plurality of normal data and a plurality of corner data associated with integrated circuits.

For example, the plurality of normal data and a plurality of corner data associated with integrated circuits may correspond to Typical-Typical (TT) corner data, but the present disclosure is not limited thereto.

In one embodiment, the plurality of fine-tuning parameter data includes the first fine-tuning parameter data, the second fine-tuning parameter data, and the third fine-tuning parameter data.

In one embodiment, the step 520 further includes the following steps: calibrating the first receiver RX2 of the host based on the plurality of fine-tuning parameter data when the performance maintenance system 100 enters a low power mode or a suspend mode.

In some embodiments, UFS driver (such as the host 121 shown in FIG. 1) keeps monitor V/T/SQ drift and apply necessary parameter update when appropriate (for example, in H8). The appropriations may be classified into the following two types:
(1) When auto H8 function is enabled, link will be in H8 when there is no data transfer for a period. (2) When system enter suspend mode, link will be in H8.

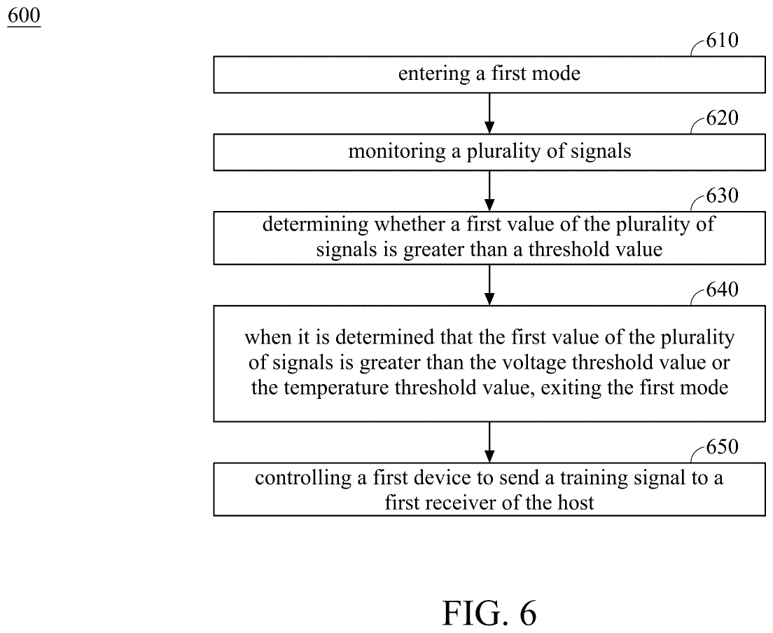

FIG. 6 is a flowchart of a performance maintenance method according to one embodiment of the present disclosure. As shown in FIG. 6, in one embodiment, the performance maintenance method 600 may include a plurality of steps 610 to 650. For a detailed description of the technical content of the plurality of steps 610 to 650 shown in FIG. 6. Please also refer to FIG. 1 to FIG. 6. The following provides a detailed explanation of the plurality of steps 610 to 650.

In the step 610, entering a first mode.

In one embodiment, the host 121 may enter the first mode 210.

In the step 620, monitoring a plurality of signals and a temperature signal.

In one embodiment, the processor 13 may monitor the plurality of signals V1 to Vn and the temperature signal ST1.

In the step 630, determining whether a first value of the plurality of signals or a second value of the temperature signal is greater than a voltage threshold value or a temperature threshold value.

In one embodiment, the processor 13 may determine whether the first value of the plurality of signals V1 to Vn or the second value of the temperature signal is greater than a voltage threshold value or a temperature threshold value.

In the step 640, when it is determined that the first value of the plurality of signals or the second value of the temperature signal is greater than the voltage threshold value or the temperature threshold value, exiting the first mode.

In one embodiment, when it is determined that the first value of the plurality of signals V1 to Vn or the second value of the temperature signal ST1 is greater than the voltage threshold value or the temperature threshold value, the host 121 may exit the first mode 210.

In the step 650, controlling a first device to send a training signal to a first receiver of the host.

In one embodiment, the host 121 may control the first device 110 to send the training signal SAPT to a first receiver RX2 of the host 121.

In one embodiment, the voltage tracker 1221 is configured to track the plurality of signals V1 to Vn in a physical layer component MH1. The temperature tracker 1222 is configured to track a temperature signal ST1 in the physical layer component MH1.

It should be understood that the above steps do not need to be performed in sequence, and each feature of the embodiments shown in FIG. 1 to FIG. 5 may be applied to the performance maintenance method 600 of FIG. 6.

In one embodiment, the first mode 210 includes a low power mode The plurality of signals V1 to Vn includes at least one of a plurality of voltage signals and a temperature signal ST1. The training signal SAPT is related to an adaptation signal.

In one embodiment, the performance maintenance method 600 further includes the following steps: monitoring a quality data; determining whether a third value of the quality data is greater than a quality threshold value; and when it is determined that the third value of the quality data is greater than the quality threshold value, exiting the first mode 210. The signal quality tracker 1223 is configured to obtain the quality data from a transport protocol layer component UP1 or the physical layer component MH1.

In one embodiment, the performance maintenance method 600 further includes the following steps: exiting the first mode 210 to transfer a data signal; sending the data signal while monitoring the plurality of signals V1 to Vn or the temperature signal ST1; determining whether the first value of the plurality of signals V1 to Vn or the second value of the temperature signal ST1 is greater than the voltage threshold value or the temperature threshold value; and when it is determined that the first value of the plurality of signals V1 to Vn or the second value of the temperature signal ST1 is greater than the voltage threshold value or the temperature threshold value, controlling the first device 110 to send a training signal SAPT to the first receiver RX 2 of the host 121.

In one embodiment, the performance maintenance method 600 further includes the following steps: determining whether the data signal is transferred; and when it is determined that the data signal is not transferred, entering the first mode 210.

In one embodiment, the performance maintenance method 600 further includes the following steps: sending the data signal while monitoring the quality data; determining whether a third value of the quality data is greater than a quality threshold value; when it is determined that the third value of the quality data is greater than the quality threshold value, controlling the first device 110 to send a training signal to the first receiver RX2 of the host 121.

In one embodiment, the performance maintenance method 600 further includes the following steps: obtaining a reference data; when it is determined that the first value of the plurality of signals V1 to Vn or the second value of the temperature signal ST1 is greater than the voltage threshold value or the temperature threshold value, sending a first fine-tuning parameter data or a second fine-tuning parameter data to the first receiver RX2 of the host 121; wherein the first fine-tuning parameter data and the second fine-tuning parameter data are related to the reference data. The first fine-tuning parameter data is related to one of the plurality of signals V1 to Vn. The second fine-tuning parameter data is related to the temperature signal ST1.

In one embodiment, the performance maintenance method 600 further includes the following steps: monitoring the quality data; determining whether a third value of the quality data is greater than a quality threshold value; and when it is determined that the third value of the quality data is greater than the quality threshold value, sending a third fine-tuning parameter data to the first receiver RX2 of the host 121. The third fine-tuning parameter data are related to the reference data. The third fine-tuning parameter data is related to the quality data. The signal quality tracker 1223 is configured to obtain the quality data from a transport protocol layer component UP1 or the physical layer component MH1.

In one embodiment, the performance maintenance method 600 further includes the following steps: collecting a plurality of fine-tuning parameter data of a look-up table data based on the plurality of signals V1 to Vn, the temperature signal ST1, the quality data, and at least one of a plurality of normal data and a plurality of corner data associated with integrated circuits. The plurality of fine-tuning parameter data includes the first fine-tuning parameter data, the second fine-tuning parameter data, and the third fine-tuning parameter data; wherein a look-up table data includes the reference data.

In one embodiment, the performance maintenance method 600 further includes the following steps: calibrating the first receiver RX2 of the host 121 based on the plurality of fine-tuning parameter data when a system (such as the performance maintenance system 100) enters a low power mode or a suspend mode.

Therefore, according to the technical content of the present disclosure, the performance maintenance system and performance maintenance method shown in the embodiment of the present disclosure can achieve the effect of continuously maintaining normal receiver operation and maintaining high performance efficiency of the system.

It should also be understood that ordinal terms such as “first” and “second” used in the specification and the claims are merely for distinguishing between similar elements, and do not imply any temporal or sequential order, nor do they indicate any order of manufacturing or arrangement between the elements. The use of such ordinals is intended solely to clarify the distinction between elements of similar designation. The terminology used in the claims may differ from that in the specification; for example, an element referred to as the “first element” in the specification may be referred to as the “second element” in the claims.

The scope of protection described in this disclosure is not limited to the processes, machines, manufacture, compositions of matter, devices, methods, or steps of the specific embodiments described in the specification. Any person of ordinary skill in the art can understand from the disclosure that any currently known or future-developed processes, machines, manufacture, compositions of matter, devices, methods, or steps that perform substantially the same function or achieve substantially the same result as those in the disclosed embodiments may be utilized in accordance with this disclosure. Therefore, the scope of protection of this disclosure includes such processes, machines, manufacture, compositions of matter, devices, methods, and steps. Any embodiment or claim of this disclosure need not achieve all of the objectives, advantages, and/or features disclosed herein.

Several embodiments have been outlined above to facilitate the understanding of the disclosed embodiments by those skilled in the art. It should be understood by those skilled in the art that they may design or modify other processes and structures based on the disclosed embodiments to achieve the same objectives and/or advantages as those described herein. It should also be understood by those skilled in the art that such equivalent processes and structures do not depart from the spirit and scope of the present disclosure, and that various modifications, substitutions, and alterations may be made without departing from the spirit and scope of the present disclosure.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A performance maintenance system, comprising:
a first device;
a host, comprising:
a host controller;
a transport protocol layer component;
a physical layer component, configured to receive a plurality of signals;
a signal tracker, configured to track the plurality of signals in the physical layer component; and
a processor, configured to execute following steps based on a plurality of instructions from a memory:
entering a first mode by the host;
monitoring the plurality of signals of the host;
determining whether a first value of the plurality of signals is greater than a threshold value;
when it is determined that the first value of the plurality of signals is greater than the threshold value, the host exits the first mode; and
controlling the first device to send a training signal to a first receiver of the host by the host.

2. The performance maintenance system as claimed in claim 1, wherein
the first mode comprises a low power mode;
wherein the plurality of signals comprises at least one of a plurality of voltage signals and a temperature signal;
wherein the training signal is related to an adaptation signal.

3. The performance maintenance system as claimed in claim 1, further comprising:
a signal quality tracker, configured to obtain a quality data from the transport protocol layer component or the physical layer component;
wherein the processor further executes the following steps based on the plurality of instructions from the memory:
monitoring the quality data of the host;
determining whether a third value of the quality data is greater than a quality threshold value; and
when it is determined that the third value of the quality data is greater than the quality threshold value, the host exits the first mode.

4. The performance maintenance system as claimed in claim 1, wherein
the signal tracker comprises a voltage tracker and a temperature tracker;
wherein the voltage tracker is configured to track the plurality of signals in the physical layer component;
wherein the temperature tracker is configured to track a temperature signal in the physical layer component;
wherein the processor further executes the following steps based on the plurality of instructions from the memory:
exiting the first mode to transfer a data signal by the host;
sending the data signal by the host while monitoring the plurality of signals or the temperature signal;
determining whether the first value of the plurality of signals or a second value of the temperature signal is greater than a voltage threshold value or a temperature threshold value; and
when it is determined that the first value of the plurality of signals or the second value of the temperature signal is greater than the voltage threshold value or the temperature threshold value, the host controls the first device to send the training signal to the first receiver of the host.

5. The performance maintenance system as claimed in claim 4, wherein
the processor further executes the following steps based on the plurality of instructions from the memory:
determining whether the data signal is transferred; and
when it is determined that the data signal is not transferred, the host enters the first mode.

6. The performance maintenance system as claimed in claim 4, wherein
the processor further executes the following steps based on the plurality of instructions from the memory:
sending the data signal by the host while monitoring a quality data;
determining whether a third value of the quality data is greater than a quality threshold value;
when it is determined that the third value of the quality data is greater than the quality threshold value, the host controls the first device to send a training signal to the first receiver of the host.

7. The performance maintenance system as claimed in claim 1, wherein
the signal tracker comprises a voltage tracker and a temperature tracker;
wherein the voltage tracker is configured to track the plurality of signals in the physical layer component;
wherein the temperature tracker is configured to track a temperature signal in the physical layer component;
wherein the processor further executes the following steps based on the plurality of instructions from the memory:
obtaining a reference data; and
when it is determined that the first value of the plurality of signals or a second value of the temperature signal is greater than a voltage threshold value or a temperature threshold value, sending a first fine-tuning parameter data or a second fine-tuning parameter data to the first receiver of the host;
wherein the first fine-tuning parameter data and the second fine-tuning parameter data are related to the reference data;
wherein the first fine-tuning parameter data is related to one of the plurality of signals;
wherein the second fine-tuning parameter data is related to the temperature signal.

8. The performance maintenance system as claimed in claim 7, further comprising:
a signal quality tracker, configured to obtain a quality data from the transport protocol layer component or the physical layer component;
wherein the processor further executes the following steps based on the plurality of instructions from the memory:
monitoring the quality data of the host;
determining whether a third value of the quality data is greater than a quality threshold value; and
when it is determined that the third value of the quality data is greater than the quality threshold value, sending a third fine-tuning parameter data to the first receiver of the host;
wherein the third fine-tuning parameter data are related to the reference data;
wherein the third fine-tuning parameter data is related to the quality data.

9. The performance maintenance system as claimed in claim 8, wherein
a look-up table data comprises the reference data;
wherein the processor further executes the following steps based on the plurality of instructions from the memory:
collecting a plurality of fine-tuning parameter data of the look-up table data based on the plurality of signals, the temperature signal, the quality data, and at least one of a plurality of normal data and a plurality of corner data associated with integrated circuits;
wherein the plurality of fine-tuning parameter data comprises the first fine-tuning parameter data, the second fine-tuning parameter data, and the third fine-tuning parameter data.

10. The performance maintenance system as claimed in claim 1, wherein
the processor further executes the following steps based on the plurality of instructions from the memory:
calibrating the first receiver of the host based on the plurality of fine-tuning parameter data when the performance maintenance system enters a low power mode or a suspend mode.

11. A performance maintenance method, comprising:
entering a first mode;
monitoring a plurality of signals;
determining whether a first value of the plurality of signals is greater than a threshold value;
when it is determined that the first value of the plurality of signals is greater than the voltage threshold value or the temperature threshold value, exiting the first mode; and
controlling a first device to send a training signal to a first receiver of a host;
wherein a signal tracker is configured to track the plurality of signals in a physical layer component.

12. The performance maintenance method as claimed in claim 11, wherein
the first mode comprises a low power mode;
wherein the plurality of signals comprises at least one of a plurality of voltage signals and a temperature signal;
wherein the training signal is related to an adaptation signal.

13. The performance maintenance method as claimed in claim 11, further comprising:
monitoring a quality data;
determining whether a third value of the quality data is greater than a quality threshold value; and
when it is determined that the third value of the quality data is greater than the quality threshold value, exiting the first mode;
wherein a signal quality tracker is configured to obtain the quality data from a transport protocol layer component or the physical layer component.

14. The performance maintenance method as claimed in claim 11, further comprising:
exiting the first mode to transfer a data signal;
sending the data signal while monitoring the plurality of signals or a temperature signal;
determining whether the first value of the plurality of signals or a second value of a temperature signal is greater than a voltage threshold value or a temperature threshold value; and
when it is determined that the first value of the plurality of signals or the second value of the temperature signal is greater than the voltage threshold value or the temperature threshold value, controlling the first device to send a training signal to the first receiver of the host.

15. The performance maintenance method as claimed in claim 14, further comprising:
determining whether the data signal is transferred; and
when it is determined that the data signal is not transferred, entering the first mode.

16. The performance maintenance method as claimed in claim 14, further comprising:
sending the data signal while monitoring a quality data;
determining whether a third value of the quality data is greater than a quality threshold value;
when it is determined that the third value of the quality data is greater than the quality threshold value, controlling the first device to send a training signal to the first receiver of the host.

17. The performance maintenance method as claimed in claim 11, further comprising:
obtaining a reference data;
when it is determined that the first value of the plurality of signals or a second value of a temperature signal is greater than a voltage threshold value or a temperature threshold value, sending a first fine-tuning parameter data or a second fine-tuning parameter data to the first receiver of the host;
wherein the first fine-tuning parameter data and the second fine-tuning parameter data are related to the reference data;
wherein the first fine-tuning parameter data is related to one of the plurality of signals;
wherein the second fine-tuning parameter data is related to the temperature signal.

18. The performance maintenance method as claimed in claim 17, further comprising:
monitoring the quality data;
determining whether a third value of the quality data is greater than a quality threshold value; and
when it is determined that the third value of the quality data is greater than the quality threshold value, sending a third fine-tuning parameter data to the first receiver of the host;
wherein the third fine-tuning parameter data are related to the reference data;
wherein the third fine-tuning parameter data is related to the quality data;
wherein a signal quality tracker is configured to obtain the quality data from a transport protocol layer component or the physical layer component.

19. The performance maintenance method as claimed in claim 18, further comprising:
collecting a plurality of fine-tuning parameter data of a look-up table data based on the plurality of signals, the temperature signal, the quality data, and at least one of a plurality of normal data and a plurality of corner data associated with integrated circuits;
wherein the plurality of fine-tuning parameter data comprises the first fine-tuning parameter data, the second fine-tuning parameter data, and the third fine-tuning parameter data;
wherein a look-up table data comprises the reference data.

20. The performance maintenance method as claimed in claim 11, further comprising:
calibrating the first receiver of the host based on the plurality of fine-tuning parameter data when a system enters a low power mode or a suspend mode.
